(19) United States
(12) Patent Application Publication
(10) Pub. No.: US 2023/0279946 A1
(43) Pub. Date: Sep. 7, 2023

(54) TRANSMISSION DEVICE

(71) Applicant: MUSASHI SEIMITSU INDUSTRY CO., LTD., TOYOHASHI-SHI, AICHI (JP)

(72) Inventor: Takashi ATSUMI, TOYOHASHI-SHI, AICHI (JP)

(21) Appl. No.: 18/008,635

(22) PCT Filed: Jun. 23, 2020
(86) PCT No.: PCT/JP2020/024609

§ 371 Date: Dec. 6, 2022

(51) Int. Cl. F16H 63/34

(52) U.S. Cl. CPC F16H 63/3433

(57) ABSTRACT

In a parking lock mechanism of a transmission device including: a transmission case including at least a first and second cases detachably coupled to each other; a transmission mechanism having a transmission shaft rotatable in the transmission case and housed in the transmission case; and a parking lock mechanism configured to lock the transmission shaft as required and housed in the transmission case, a detent arm has a rotation fulcrum located in the first case while an engagement portion between the detent arm and a detent spring is located in the second case, the first case is provided with a support protrusion protruding toward the second caserelative to a mating surface between the first and second cases, and a fixed end of the detent spring is attached to the support protrusion on the second case side relative to the mating surface.

### TECHNICAL FIELD

The present invention relates to a transmission device, and in particular to a transmission device that comprises: a transmission case including at least first and second cases detachably coupled to each other; a transmission mechanism having a transmission shaft rotatable in the transmission case and housed in the transmission case; and a parking lock mechanism configured to lock the transmission shaft as required and is provided in the transmission case.

### BACKGROUND ART

In the aforementioned transmission device, the parking lock mechanism comprising a parking gear provided to a transmission shaft in a manner non-rotatable relative to the transmission shaft; a parking pawl that can lock the parking gear by engaging with the parking gear; a rod that is driven to rotate the parking pawl to a lock position for engagement with the parking gear and an unlock position for disengagement from the parking gear; a detent arm whose base portion is rotatably supported by a first case and which is coupled to the rod so that the rod is driven by rotation thereof; and a detent spring disengageably engaged with a tip portion of the detent arm to resiliently hold the detent arm in a specific arm rotation position, wherein the parking pawl is movable between the lock position and the unlock position by switching the arm rotation position of the detent arm, is conventionally known as disclosed in Patent Document 1, for example.

### PRIOR ART DOCUMENTS

### Patent Documents

Patent Document 1: Japanese Unexamined Patent Application

### SUMMARY OF THE INVENTION

### Problems to Be Solved by the Invention

In the conventional transmission device, the detent arm has a rotation angle and an arm length for axially moving the rod by the rotation of the detent arm, and requires a sufficient rotation space for the rotation angle and the arm length. Attempting to ensure all the rotation space in the first case causes the first case, and thus the transmission case, to increase in size.

If the detent arm is arranged so as to extend across the first and second cases, inside of the second case can be also used for the rotation space of the detent arm, and the first case can decrease in size. As an arrangement and attachment structure of the detent spring in this case, for example, [1] a base end portion (that is, a fixed end) of the detent spring may be attached to the second case, or [2] the base end portion of the detent spring may be attached to the first case, and then a tip end portion (that is, a free end) of the detent spring may be extended from the attachment portion to the tip portion of the detent arm in the second case.

Both the aforementioned structures [1] and [2] have advantages and disadvantages, however. Specifically, in the case of [1], the detent spring and the detent arm, that are in a mutually engaged state after the first and second cases are coupled, are in a disengaged state before the two cases are coupled. Therefore, at the time of coupling the two cases, the detent spring and the detent arm has to be engaged with each other tactilely without being sufficiently visible from the outside. Thus, there is a disadvantage that assembling workability deteriorates.

On the other hand, in the case of [2], as is clear from FIG. 9(b), an angle β formed by a tangent line Y of a contact portion between the tip portion of the detent arm and the tip end portion (for example, a roller) of the detent spring and an imaginary straight line Z connecting a starting point of bending deformation of the detent spring and the center of the roller becomes relatively large. Therefore, in the case of [2], a larger operation torque is required to rotate the detent arm against the detent spring than in the case of [1]. There is a disadvantage that operability of the detent arm deteriorates.

The present invention has been proposed in view of the above. An object of the present invention is to provide a transmission device that can solve the above problem in the conventional structure at once with a simple structure.

### Means for Solving the Problems

In order to achieve the above object, a first aspect of the present invention provides a transmission device comprising: a transmission case including at least first and second cases detachably coupled to each other; a transmission mechanism having a transmission shaft rotatable in the transmission case and housed in the transmission case; and a parking lock mechanism configured to lock the transmission shaft as required and provided in the transmission case, the parking lock mechanism comprising: a parking gear provided to the transmission shaft in a manner non-rotatable relative to the transmission shaft; a parking pawl configured to lock the parking gear by engaging with the parking gear; a rod driven to move the parking pawl to a lock position for engagement with the parking gear and an unlock position for disengagement from the parking gear; a detent arm whose base portion is rotatably supported by the first case and which is coupled to the rod so that the rod is driven by rotation thereof; and a detent spring disengageably engaged with a tip portion of the detent arm to resiliently hold the detent arm in a specific arm rotation position, wherein the detent arm has a rotation fulcrum located in the first case while an engagement portion between the detent arm and the detent spring is located in the second case, and wherein the first case is provided with a support protrusion protruding toward the second case relative to a mating surface between the first and second cases, and a fixed end portion of the detent spring is attached to the support protrusion on the second case side relative to the mating surface.

According to a second aspect of the present invention, in addition to the first aspect, the support protrusion is configured by a support member separate from the first case, and the support member is fixed to the first case.

According to a third aspect of the present invention, in addition to the second aspect, the support member has a rod guide portion that guides a movement of the rod.

According to a fourth aspect of the present invention, in addition to any of the first to third aspects, the rod extends in a direction substantially orthogonal to a rotation axis of the detent arm as viewed in a projection plane orthogonal to the transmission shaft, and is arranged to overlap with the detent spring in an axial direction of the transmission shaft.

### Effects of the Invention

According to the first aspect, while the detent arm has the rotation fulcrum located in the first case, the engagement portion between the detent arm and the detent spring is located in the second case. The first case is provided with the support protrusion protruding toward the second case relative to the mating surface between the first and second cases. The fixed end portion of the detent spring is attached to the support protrusion on the second case side relative to the mating surface. As a result, an internal space of the second case can be utilized as a part of the rotation space of the detent arm, and the first case, and thus the transmission case, can decrease in size accordingly. Moreover, since both the detent arm and the detent spring are collectively attached to the first case, engaging work of the two can be easily and accurately performed on the first case side before the first and second cases are coupled. Thus, assembling workability is favorable. In addition, since the position of the fixed end portion of the detent spring is close to the second case, a pressing and bending force can be efficiently applied to the detent spring from the detent arm at the time of rotation operation of the detent arm. Thus, the operation torque for rotating the detent arm against the detent spring is reduced, and operability of the detent arm is improved.

According to the second aspect, the support protrusion for attaching the fixed end portion of the detent spring is configured by the support member separate from the first case, and the support member is fixed to the first case by retrofitting. Thus, even if the support protrusion protrudes toward the second case relative to the mating surface, it is possible to easily and accurately process the mating surface without being disturbed by the support protrusion.

According to the third aspect, the support member has the rod guide portion that guides the movement of the rod that moves the parking pawl to the lock position and the unlock position. Thus, the support member for raising and attaching the fixed end portion of the detent spring is also used as a guide member for the movement of the rod, and accordingly, can contribute to simplification of the structure of the device.

According to the fourth aspect, the rod extends in the direction substantially orthogonal to the rotation axis of the detent arm as viewed in the projection plane orthogonal to the transmission shaft, and is arranged to overlap with the detent spring in the axial direction of the transmission shaft. Due to the overlapping arrangement of the rod and the detent spring, the parking lock mechanism can decrease in size in the rotation axis direction of the detent arm.

### BRIEF DESCRIPTION OF THE DRAWINGS

FIG. 1 is a view of an internal structure of a transmission device according to an embodiment of the present invention as viewed from the right side in a state where a second case of a transmission case, bearings attached to the second case, etc. are removed (a view shown by arrow 1 in FIG. 2).

FIG. 2 is a sectional view taken along line 2-2 in FIG. 1.

FIG. 3 is a sectional view of an essential part of a parking lock mechanism (an enlarged sectional view of a part shown by arrow 3 in FIG. 1).

FIG. 4 is a sectional view taken along line 4-4 in FIG. 3 with the second case omitted.

FIG. 5 is a perspective view showing a positional relationship between the parking lock mechanism and a first case.

FIG. 6 is a perspective view of each part of the parking lock mechanism as viewed from a different direction from that of FIG. 5.

FIG. 7 is an exploded perspective view of the parking lock mechanism as viewed from the same direction as that of FIG. 6.

FIGS. 8(a) and 8(b) are schematic operation explanatory diagrams showing a relative movement of each part of the parking lock mechanism, where FIG. 8(a) is a diagram showing a locked state, and FIG. 8(b) is a diagram showing an unlocked state (solid line) and a partially unlocked state (chain line).

FIGS. 9(a) and 9(b) are explanatory diagrams for explaining a difference in an amount of force exerted by the detent arm on the detent spring during a rotation operation of the detent arm, where FIG. 9(a) is a diagram illustrating the embodiment and FIG. 9(b) is a diagram illustrating a comparative example.

### EXPLANATION OF REFERENCE NUMERALS

G...reduction gear mechanism as a transmission mechanism
R...speed reduction device as a transmission mechanism
S...input shaft as a transmission shaft
10...transmission case
11, 12...first and second cases
f...mating surface
20...parking lock mechanism
21... parking gear
22...detent shaft as a rotation fulcrum
23...parking pawl
23L, 23UL...lock position, unlock position
26...detent arm
26a, 26b...tip portion and base portion of the detent arm
27...rod
28...detent spring
28b: base end portion as a fixed end portion
40...support member as a support protrusion
40g...rod guide portion

### MODE FOR CARRYING OUT THE INVENTION

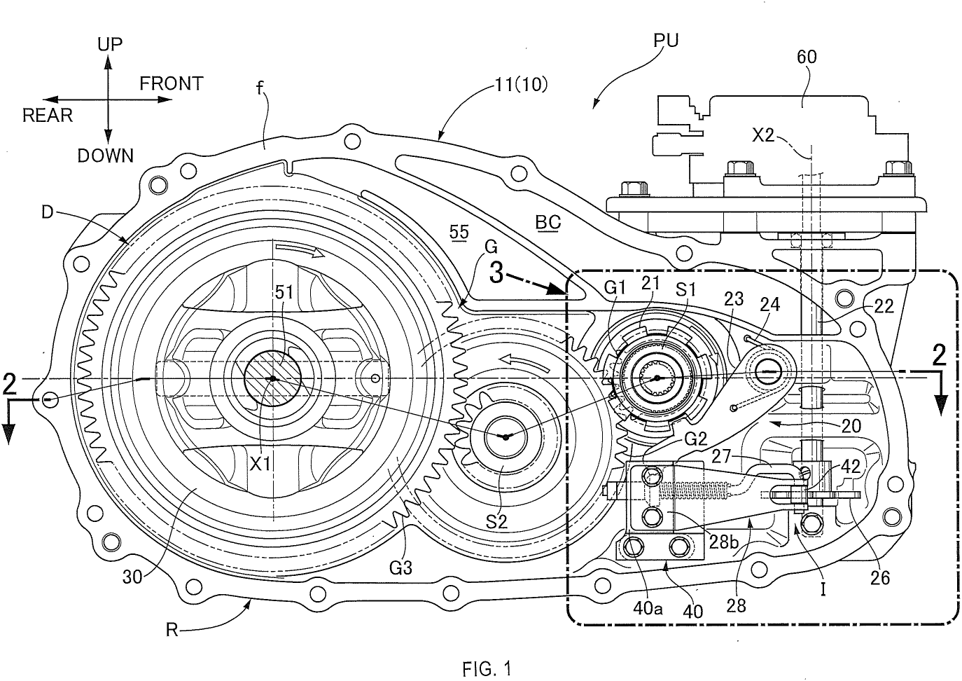

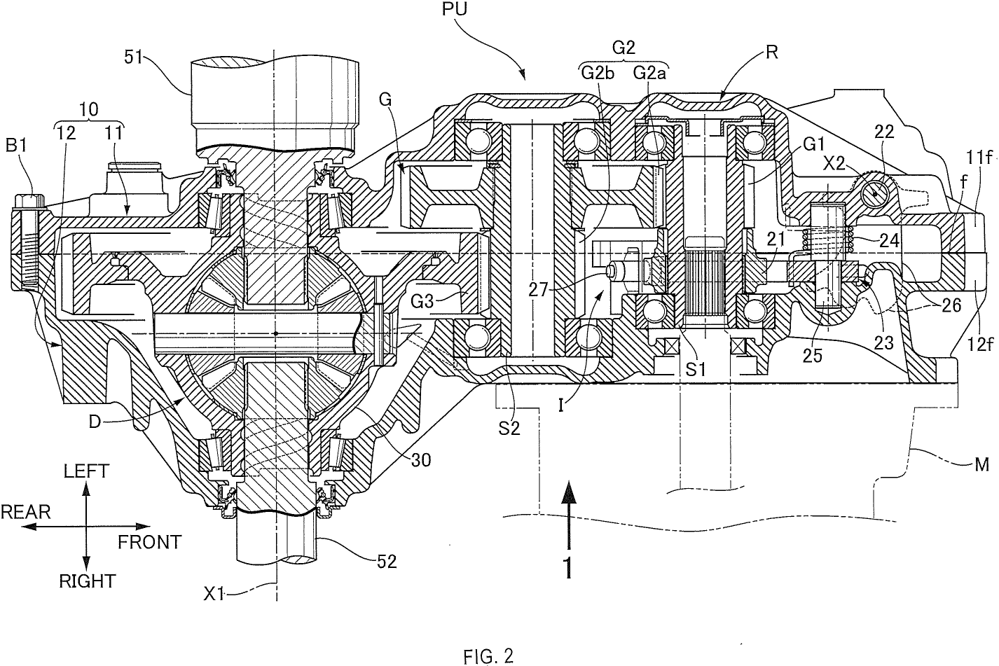

First, in FIGS. 1 and 2, a power unit PU mounted in a vehicle, for example, an automobile, comprises an electric motor M (see the chain line in FIG. 2) as a power source, a speed reduction device R that decelerates an output of the electric motor M, and a differential device D that distributes the output of the reduction device R to first and second output shafts 51 and 52 on the left and right while allowing differential rotation.

The speed reduction device R is an example of a transmission device of the present invention, and comprises a transmission case 10 supported in an appropriate position on the vehicle body. The transmission case 10 houses a reduction gear mechanism G as a transmission mechanism, a parking lock mechanism 20 that can lock rotation of an input shaft S1 in the reduction gear mechanism G as required, and the above-described differential device D. A motor case of the electric motor M is mounted on one side surface of the transmission case 10 (more specifically, an outer side surface of a second case 12 to be described later) in a position offset from the differential device D.

Front-rear, left-right, up-down directions herein refer to front-rear, left-right, up-down directions in a state where the power unit PU is mounted in the vehicle.

The transmission case 10 is divided into a pair of left and right first and second cases 11 and 12. The first and second cases 11 and 12 integrally have attachment flanges 11f and 12f that overlap each other at their outer peripheral portions, respectively. The first and second cases 11 and 12 are detachably coupled to each other by bolts B1 that penetrate a mating surface f between the attachment flanges 11f and 12f. Thus, the mating surface f is on the same plane as a plane that extends vertically and in the front-rear directions, and forms a mating surface between the first and second cases 11 and 12.

The reduction gear mechanism G comprises: an input gear G1 fixed to the input shaft S1; an intermediate gear G2 fixed to and supported by an intermediate shaft S2 located behind and below the input shaft S1 and parallel to the input shaft S1, the intermediate gear G2 meshing with the input gear G1; and an output gear G3 meshing with the intermediate gear G2. The output gear G3 is arranged in a manner rotatable about a specified axis X1 parallel to the input shaft S1 (that is, an axis of the first and second output shafts 51 and 52).

The input shaft S1 and the intermediate shaft S2 are rotatably supported at both end portions by the first and second cases 11 and 12 around a horizontal axis via bearings. Also, in the present embodiment, the intermediate gear G2 is configured by a two-stage gear including a first intermediate gear portion G2a and a second intermediate gear portion G2b. The first intermediate gear G2a has a large diameter and meshes with the input gear G1. The second intermediate gear portion G2b has a small diameter, rotates integrally and coaxially with the first intermediate gear portion G2a, and meshes with the output gear G3. The intermediate gear G2 reduces the rotation of the input gear G1 in two stages and transmits the rotation to the output gear G3 side.

The input shaft S1 is linked and coupled to a not shown output shaft of the electric motor M, and receives a rotational driving force from the electric motor M. The input shaft S1 is an example of a transmission shaft of the present invention. The output gear G3 is fixed (for example, welded) to an outer peripheral portion of a differential case 30 in the differential device D.

Lubricating oil is stored in a bottom portion of the transmission case 10, and an oil surface thereof is set to such an extent that lower portions of the intermediate gear G2 and the output gear G3 are partially immersed. Thus, during the transmission of the reduction gear mechanism G, the input gear G1, the intermediate gear G2, and the output gear G3 rotate in a direction of, for example, a white arrow in FIG. 1, and with the rotation, some of the lubricating oil splashed and scattered by the intermediate gear G2 is directed to the parking lock mechanism 20 side, and some of the lubricating oil splashed and scattered by the output gear G3 is directed to an inlet side of an oil collection tank 55 disposed in an upper portion of the transmission case 10.

Oil holes, which are not shown, are provided in the bottom wall of the oil collection tank 55, and the lubricating oil in the oil collection tank 55 is dropped from these oil holes to the reduction gear mechanism G, mainly to the intermediate gear G2 and the output gear G3. A breather chamber BC is provided in the upper portion of the transmission case 10 adjacent to the oil collection tank 55, and the inside of the transmission case 10 communicates with the atmosphere via the breather chamber BC.

The structure and function of the differential device D are well known in the art. The differential case 30 of the differential device D of the present embodiment comprises, for example, a gear-type differential mechanism and is rotatably supported by the transmission case 10. The rotational driving force input from the output gear G3 to the differential case 30 is distributed and transmitted to the first and second output shafts 51 and 52 while allowing differential rotation. This rotates and drives left and right driving wheels connected to the first and second output shafts 51 and 52.

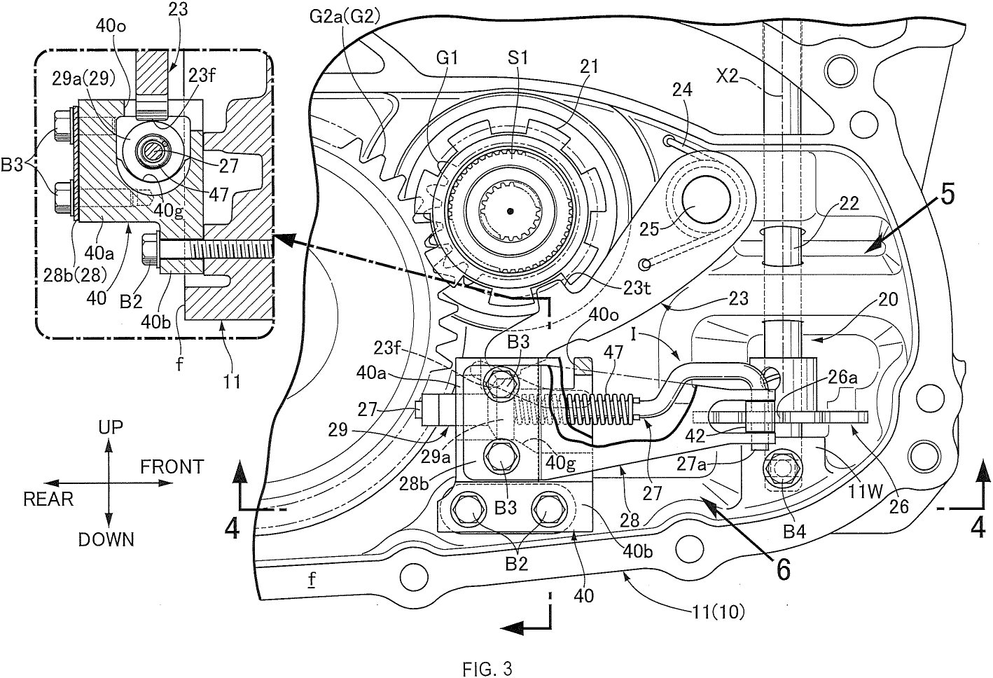

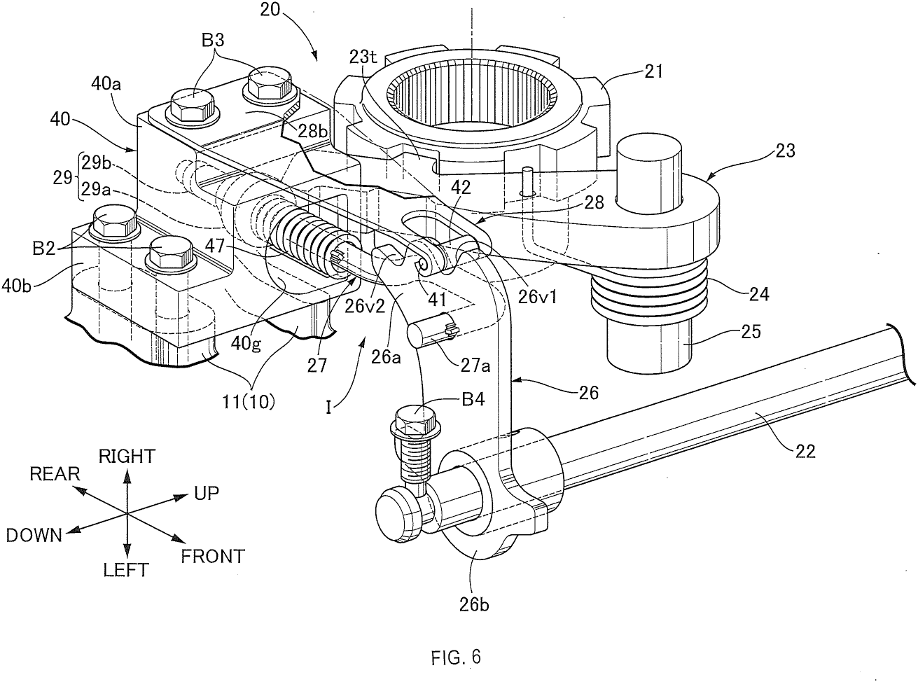

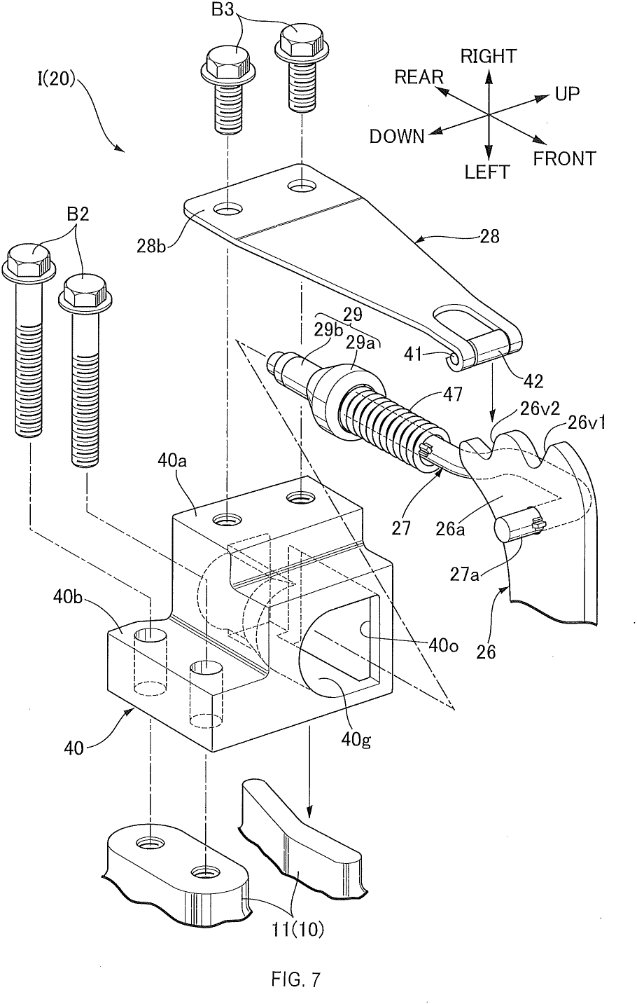

Next, an example of the parking lock mechanism 20 will be described with reference to FIGS. 3 to 8(b).

The parking lock mechanism 20 of the present embodiment comprises a parking gear 21 fixed to the input shaft S1 on the side of the input gear G1, a detent shaft 22 supported by the first case 11 in a manner rotatable about a rotation axis X2 in the up-down directions, a parking pawl 23 engageable with and disengageable from the parking gear 21 in conjunction with the rotation of the detent shaft 22, a return spring 24 constantly biasing the parking pawl 23 in a direction away from the parking gear 21 (that is, a direction to disengage the parking pawl 23 from the parking gear 21), and an interlocking mechanism I configured to engage or disengage the parking pawl 23 with or from the parking gear 21 in conjunction with the rotation of the detent shaft 22.

A base portion of the parking pawl 23 is swingably supported by the transmission case 10 via a pivot shaft 25 having both end portions fitted to and supported by inner walls of the first and second cases 11 and 12. The parking pawl 23 has a protruding claw portion 23t that can be locked to the parking gear 21 on one side of an intermediate portion near the tip end thereof, and has a pressed portion 23f that receives a pressing force from a later-described cam member 29 of the interlocking mechanism I on the other side of the tip end portion.

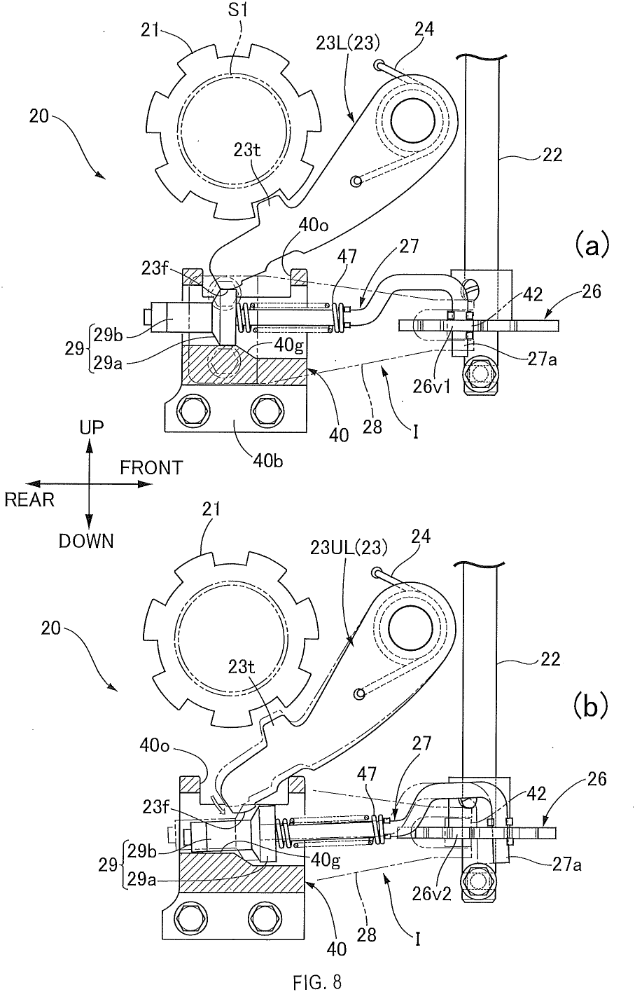

The parking pawl 23 is swingable about the axis of the pivot shaft 25 between the lock position 23L (see FIG. 8(a)) where the protruding claw portion 23t engages with the parking gear 21 to regulate rotation of the input shaft S1 and the unlock position 23UL (see FIG. 8(b)) located on a side away from the parking gear 21 across the lock position 23L, where the engagement is released.

The interlocking mechanism I comprises: a detent arm 26 that has a base portion 26b fixed (screwed in the example drawing) to the detent shaft 22 and rotates integrally with the detent shaft 22; a rod 27 that has a base end portion 27a pivotally coupled to an intermediate portion of the detent arm 26 near a tip portion 26a; a detent spring 28 that selectively engages with engaged portions (for example, positioning recesses 26v1 and 26v2) provided in the tip portion 26a of the detent arm 26 to hold the detent arm 26 in a specific rotation position (first or second rotation position to be described later); a cam member 29 that is slidably fitted and held in a tip portion of the rod 27 within a specified axial range and can be in contact with and separated from the parking pawl 23; and a buffer spring 47 that biases the cam member 29 to a sliding limit on one side (that is, on the tip end side of the rod 27) within the specified range and holds the cam member 29.

The base end portion 27a of the rod 27 is bent in a hook shape and penetrates the detent arm 26 perpendicularly.

As is clear from FIGS. 8(a) and 8(b), the cam member 29 is formed in a stepped cylindrical shape having a small diameter portion 29b and a large diameter portion 29a continuously provided to one end of the small diameter portion 29b on the detent arm 26 side. The small diameter portion 29b and the large diameter portion 29a are connected by a tapered stepped surface (cam surface). The buffer spring 47 is compressed between a spring receiving protrusion protruding from an outer periphery of the intermediate portion of the rod 27 and the large diameter portion 29a of the cam member 29.

Thus, when the detent arm 26 is in the first rotation position shown in FIG. 8(a), the cam member 29 can push up and hold the parking pawl 23 toward the lock position 23L as the large diameter portion 29a engages with the pressed portion 23f of the parking pawl 23. In this case, the buffer spring 47 is effective in absorbing and mitigating an impact when the large diameter portion 29a of the cam member 29 contacts the pressed portion 23f and pushes up the parking pawl 23.

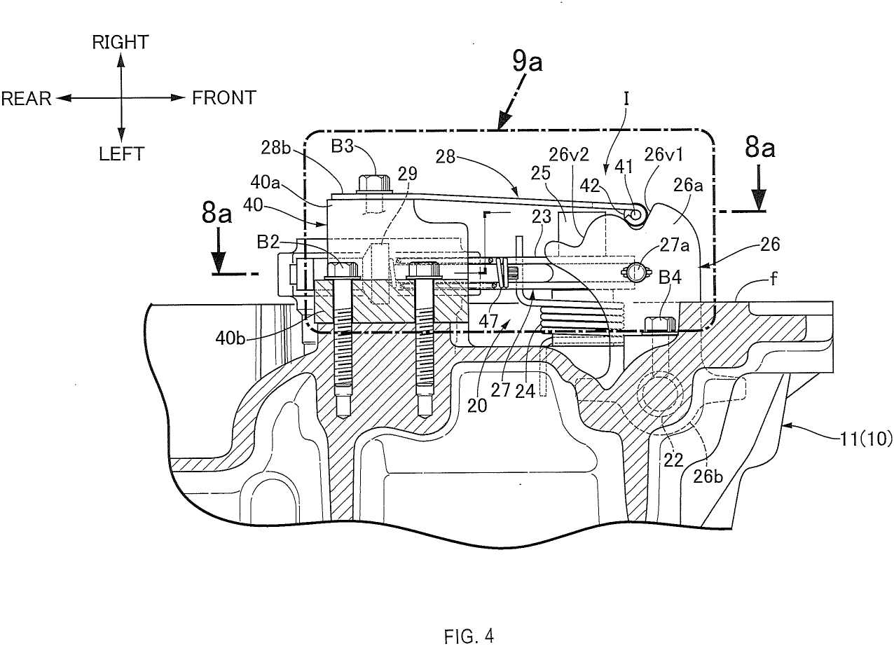

As is clear from FIG. 4, the detent spring 28 is configured by a leaf spring extending substantially along the mating surface f between the first and second cases 11 and 12 in a side view, and is entirely arranged in the second case 12. A base end portion 28b of the detent spring 28 as a fixed end portion thereof is attached to the inner surface of the first case 11 via the support member 40.

The tip portion of the detent spring 28 is formed in a fork shape to avoid interference with the detent arm 26, and a tip end portion thereof is wound into an eyeball shape to support both ends of a roller support shaft 41. A roller 42 that is engageable with and disengageable from the engaged portions (positioning recesses 26v1 and 26v2) provided in the tip portion 26a of the detent arm 26 is rotatably held in an intermediate portion of the roller support shaft 41. An engagement portion between the tip portion (roller 42) of the detent spring 28 and the detent arm 26 is located on the second case 12 side relative to the mating surface f.

Next, an example of the support member 40 will be described mainly with reference to FIGS. 3 to 7. The support member 40 is configured by a frame body separate from the first case 11, and is formed in a hollow box shape having rigidity. The support member 40 is fixed to the first case 11 by being retrofitted with bolts B2 on one side of the base portion 40b. A tip portion 40a of the support member 40 protrudes toward the second case 12 relative to the mating surface f, and the base end portion 28b, that is, the fixed end portion of the detent spring 28 is attached (for example, fixed by bolts B3) to the tip portion 40a.

Thus, the support member 40, on the first case 11, raises a height position of its fixed support portion relative to the detent spring 28 to the second case 12 side beyond the mating surface f, and is one example of a support protrusion of the present invention. In the present embodiment, the support member 40 is separate from the first case 11, but the support protrusion that performs the same function as the support member 40 may be integrally formed on the inner wall of the first case 11.

Thus, the detent arm 26 is arranged such that a rotation fulcrum (that is, the detent shaft 22) thereof is located in the first case 11 while the tip portion 26a thereof protrudes into the second case 12 beyond the mating surface f, and the engagement portion between the protruding tip portion 26a and the detent spring 28 is located in the second case 12.

The support member 40 of the present embodiment has a hollow rod guide portion 40g that allows the rod 27 with the cam member 29 to axially and slidably penetrate the rod guide portion 40g and holds the rod 27 in an embracing manner to guide an axial movement of the rod 27 (and thus the cam member 29). The rod guide portion 40g functions to restrict the cam member 29 from deviating from the position corresponding to the parking pawl 23, and this allows the cam member 29 to always and accurately engage with and press the pressed portion 23f of the parking pawl 23.

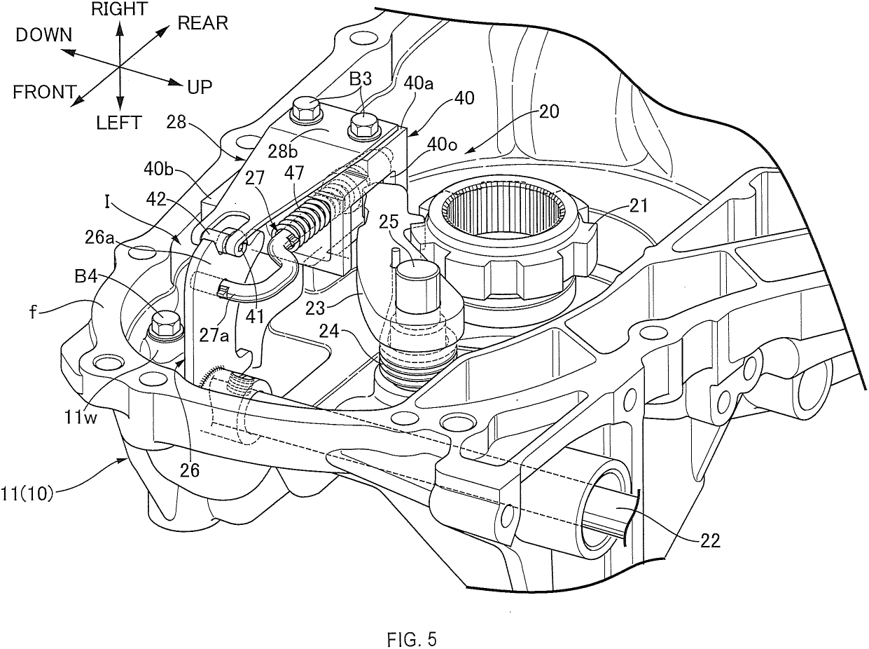

Moreover, as is clear from FIGS. 5, 8(a) and 8(b), the support member 40 has an opening 40o that allows the pressed portion 23f of the parking pawl 23 to protrude into the support member 40. That is, the pressed portion 23f of the parking pawl 23 is engageable with and disengageable from the cam member 29 (large diameter portion 29a) on the rod 27 through the opening 40o.

Particularly, as is clear from FIG. 8(b), the peripheral edge portion of the opening portion 40o of the embodiment can be engaged with the intermediate portion of the parking pawl 23 biased by the return spring 24 in a direction of disengagement from the parking gear 21. That is, by the engagement, the peripheral edge portion of the opening portion 40o functions as a stopper that restricts a rearward movement limit of the parking pawl 23 in the disengagement direction.

The rod 27 of the present embodiment extends in a direction substantially orthogonal to the rotation axis X2 of the detent arm 26 as viewed in a projection plane (see FIG. 3) orthogonal to the input shaft S1, and is arranged to overlap with the detent spring 28 in an axial direction of the input shaft S1 (that is, the left-right directions).

FIGS. 1 and 3 show a locked state of the parking lock mechanism 20. In this state, the detent arm 26 (and thus the detent shaft 22) is in the first rotation position and, as is clear from FIG. 8(a), the large diameter portion 29a of the cam member 29 on the rod 27 pushes up to the lock position 23L and holds the parking pawl 23 against a resilient force of the return spring 24. This state is maintained by the detent spring 28 resiliently engaging with the first positioning recess 26v1 of the detent arm 26 to hold the detent arm 26 in the first rotation position.

When the detent arm 26 (and thus the detent shaft 22) is rotated to the second rotation position from the locked state, the rod 27 is pulled forward in conjunction with the rotation operation. Accordingly, as is clear from FIG. 8(b), the pressed portion 23f of the parking pawl 23 faces the small diameter portion 29b of the cam member 29, and the push-up force of the cam member 29 against the parking pawl 23 is released. This allows the parking pawl 23 to swing rearward to the unlock position 23UL by the resilient force of the return spring 24, and the parking lock mechanism 20 is brought into the unlocked state. This state is maintained by the detent spring 28 resiliently engaging with the second positioning recess 26v2 of the detent arm 26 to hold the detent arm 26 in the second rotation position.

The detent shaft 22 extends in the up-down directions in the first case 11, and an axial intermediate portion thereof is rotatably fitted to and supported by bulging wall portions on the inner surface of the first case 11. A retaining bolt B4 that engages with an annular groove on an outer periphery of the detent shaft 22 in a relatively rotatable manner is screwed to a portion of the bulging wall portions (a lowermost bulging wall portion 11w in the illustrated example).

Further, an actuator 60 for rotating the detent shaft 22 is attached to the upper portion of the first case 11. The actuator 60 can selectively rotate the detent shaft 22 (and thus the detent arm 26) between the first rotation position and the second rotation position. The actuator 60 is connected to an in-vehicle electronic controller (not shown), and energization control of the actuator 60 is performed in accordance with an operation input by an occupant to a not shown parking operation portion provided in a driver’s seat.

Next, the operation of the above embodiment will be described. In the power unit PU, when the rotational driving force is input from the electric motor M to the input shaft S1, the rotational driving force is decelerated by the speed reduction device R as a transmission device and transmitted to the output gear G3. The rotational driving force of the output gear G3 is distributed to the first and second output shafts 51 and 52 by the differential device D while allowing differential rotation, and is further transmitted from the first and second output shafts 51 and 52 to the left and right drive wheels.

Also, the energization control of the actuator 60 is performed in accordance with the operation input to the parking operation portion. This selectively rotates the detent arm 26 between the first rotation position (FIG. 8(a)) and the second rotation position (FIG. 8(b)) via the detent shaft 22. For example, when the detent arm 26 is in the first rotation position, the parking lock mechanism 20 is in the above-described locked state, that is, a rotation restricted state of the input shaft S1, and when the detent arm 26 is in the second rotation position, the parking lock mechanism 20 is in the above-described unlocked state, that is, a rotation allowable state of the input shaft S1.

In the parking lock mechanism 20 of the present embodiment, as is clear from FIGS. 4 and 5, the rotation fulcrum (that is, the detent shaft 22) of the detent arm 26 is located in the first case 11 while the engagement portion with the detent spring 28 is located in the second case 12. The support member 40 as the support protrusion protruding toward the second case 12 relative to the mating surface f is provided in the first case 11, and the base end portion 28b of the detent spring 28 is fixed to the support member 40 on the second case 12 side relative to the mating surface f. This makes it possible to utilize the internal space of the second case 12 as a part of the arrangement space for the detent spring 28 and the rotation space of the detent arm 26. Accordingly, it is possible to make the first case 11 and the transmission case 10 smaller.

Moreover, since the detent arm 26 and the detent spring 28 are collectively attached to the common case, that is, the first case 11, the engaging work of the two components 26 and 28 can be completed easily and accurately on the first case 11 side before coupling of the first and second cases 11 and 12. Thus, assembling workability is excellent.

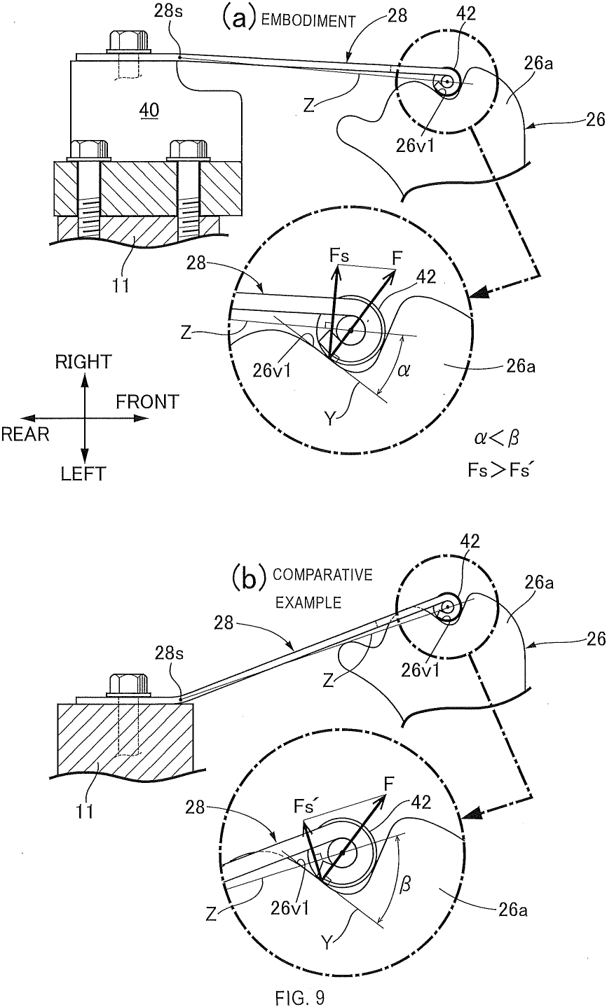

Moreover, in the present embodiment, since the fixed position of the base end portion 28b of the detent spring 28 is close to the second case 12, the pressing and bending force can be efficiently applied to the detent spring 28 from the detent arm 26 at the time of the rotation operation of the detent arm 26. Thus, operability of the detent arm 26 becomes favorable. The principle of operation will be described in detail below with reference to FIGS. 9(a) and 9(b).

That is, when the detent arm 26 is rotated between the first and second rotation positions as mentioned above, the roller 42 at the tip of the detent spring 28 transfers from one of the first and second positioning recesses 26v1 and 26v2 in the tip portion of the detent arm 26 to the other against a resilient force of the spring 28, and the rotation position of the detent arm 26 is switched.

In this case, the arrangement posture of the detent spring 28 differs between a structure in which a height position of the base end portion 28b of the detent spring 28 is raised by the support member 40 as in the embodiment shown in FIG. 9(a) and a structure in which the height position is not raised as in a comparative example shown in FIG. 9(b). That is, in the structure of the embodiment, the detent spring 28 is in a posture substantially along the mating surface f, whereas in the structure of the comparative example, the detent spring 28 is in an inclined posture in which the detent spring 28 rises at a relatively large angle from the base end toward the tip end with respect to the mating surface f.

Due to such a difference in the arrangement posture of the detent spring 28, an angle formed by a tangent line Y of a contact portion between the tip portion 26a (for example, the positioning recess 26v1) of the detent arm 26 and the roller 42 at the tip of the detent spring 28 and an imaginary straight line Z connecting a starting point 28s of the bending deformation of the detent spring 28 and the center of the roller 42 is smaller in angle α of the embodiment than in angle β of the comparative example, as is clear from FIGS. 9(a) and 9(b). In this relation, when the detent arm 26 exerts a pressing force F in the normal direction on the roller 42 during the rotation operation, a magnitude of a bending direction component force of the pressing force F with respect to the detent spring 28 (that is, a pressing force component in a direction orthogonal to the imaginary straight line Z) differs between the embodiment and the comparative example. That is, a component force Fs of the embodiment is larger than a component force Fs′ of the comparative example in relation to the difference between the angles α and β.

Thus, when the tip end of the detent spring 28, that is, the roller 42, is pressed by the tip portion 26a of the detent arm 26 for switching the rotation position of the detent arm 26, the embodiment can apply the pressing and bending force to the detent spring 28 more efficiently even with the same pressing force F. Therefore, since the operation torque for rotating the detent arm 26 against the detent spring 28 is smaller in the embodiment than in the comparative example, operability of the detent arm 26 is more favorable in the embodiment.

In the present embodiment, it is desirable to set the fixed position of the base end portion 28b of the detent spring 28 and a height from the mating surface f so that the angle α is 60 degrees or less. The reason is because the bending direction component force Fs of the pressing force F with respect to the detent spring 28 decreases as the angle α increases, and rotation operability of the detent arm 26 decreases.

The support member 40 to which the base end portion 28b of the detent spring 28 of the present embodiment is attached is a separate part from the first case 11, and is fixed to the first case 11 by retrofitting. Thus, even if the support member 40 protrudes toward the second case 12 relative to the mating surface f after the assembly is finished (that is, after the first and second cases 11 and 12 are coupled), machining of the mating surface f can be easily and accurately performed without being disturbed by the support member 40 (that is, without requiring measures to avoid interference between the support member 40 and a machining tool) before the assembly (particularly, before the assembly of the support member 40).

The support member 40 of the present embodiment has the rod guide portion 40g that allows the rod 27 to axially penetrate and guides the axial movement of the rod 27. This allows the support member 40 that raises and attaches the base end portion 28b of the detent spring 28 to be also used as a guide member for the axial movement of the rod 27. Thus, the support member 40 can contribute to simplification of the device.

The rod 27 of the present embodiment extends in the direction substantially orthogonal to the rotation axis X2 of the detent arm 26 as viewed in the projection plane orthogonal to the input shaft S1 (see FIG. 3), and is arranged to overlap with the detent spring 28 in the axial direction (that is, the left-right directions) of the input shaft S1. According to this overlapping arrangement, the rod 27 and the detent spring 28 are in a positional relationship in which most of the two overlap as viewed in the aforementioned projection plane. That is, the rod 27 and the detent spring 28 are not in a positional relationship in which the two expands in an axial direction of the detent shaft 22. Thus, it is advantageous in decreasing the size of the parking lock mechanism 20 (particularly, interlocking mechanism I) in a direction along the rotation axis X2 of the detent arm 26.

Further, according to the structure in which the rod 27 and the detent spring 28 are arranged in an overlapping manner as described above and the structure in which the support member 40 for supporting the detent spring 28 has the rod guide portion 40g through which the rod 27 penetrates, there is no need to arrange the support member 40 adjacent to the rod 27 on one side (that is, the rear side) in a rod longitudinal direction. Accordingly, it is advantageous in decreasing the size of the parking lock mechanism 20 (particularly, the interlocking mechanism I) in the rod longitudinal direction. A supplementary explanation of this effect is that, for example, in a case where the support member 40 is a solid block body and has a structure without the rod guide portion 40g through which the rod 27 penetrates, an attempt is made to arrange the rod 27 to overlap the detent spring 28 while avoiding interference between the support member 40 and the rod 27. Then, the support member 40 must be displaced rearward in the longitudinal direction of the rod 27 relative to the installation position of the embodiment, and there is a disadvantage that the size of the interlocking mechanism I increases in the longitudinal direction of the rod 27 by the displacement.

In the above embodiment, the input gear G1 and the parking gear 21 are attached to the input shaft S1 of the speed reduction device R as a transmission device, and the electric motor M that is adjacent and fixed to the transmission case 10 (that is, the second case 12) is coupled to the input shaft S1. In terms of the arrangement space of the electric motor M, the housing of the electric motor M is larger in a radial direction of the input shaft S1 than a general component (for example, input gear G1) around the input shaft S1 of the speed reduction device R as viewed in the projection plane orthogonal to the input shaft S1. Therefore, in the structure in which the electric motor M is adjacent and fixed to the transmission case 10, a large dead space related to the radial size of the electric motor M is generated around the input shaft S1 in the transmission case 10. In contrast, in the present embodiment, since the parking lock mechanism 20 is linked to the input shaft S1, the main components of the parking lock mechanism 20 can be laid out around the input shaft S1, and the dead space can be effectively utilized.

Also, the second case 12 of the transmission case 10 has design constraints for fixing the electric motor M adjacent to the transmission case 10. In the embodiment, while a portion of the parking lock mechanism 20 can protrude into the second case 12 to contribute to decreasing the size of the first case 11, most of the parking lock mechanism 20 is attached to the first case 11. Thus, a portion of the second case 12 corresponding to the electric motor M is made smaller as much as possible without violating the aforementioned constraints, and it is therefore advantageous in terms of decreasing the size of the transmission case 10 as a whole.

An embodiment of the present invention is explained above, but the present invention is not limited to the embodiment and may be modified in a variety of ways as long as the modifications do not depart from the subject matter.

For example, the above embodiment illustrates the speed reduction device R in the power unit PU for a vehicle as an example of a transmission device, but the transmission device may be a speed increase device or a speed change device.

The above embodiment illustrates the input shaft S1 of the speed reduction device R as a transmission shaft subject to rotation restriction by the parking lock mechanism 20. However, the transmission shaft is not limited to the input shaft, and may be a rotating shaft responsible for at least power transmission.

The above embodiment illustrates the case in which rotation operation of the detent shaft 22 (and thus, the detent arm 26) of the parking lock mechanism 20 is electrically performed using the actuator 60 fixed to the transmission case 10. Alternatively, in the present invention, the actuator may be omitted, and the detent shaft 22 may be linked and coupled to a manual operating portion of the driver’s seat so that the detent shaft 22 is manually operated by the driver.

The above embodiment illustrates the transmission case divided into the first and second cases. Alternatively, the transmission case may be divided into three or more cases, and the structure of the present invention may be applied to first and second cases among those three or more cases.

The above embodiment illustrates the case in which the rod 27 is not bent except at the base end portion 27a, but the rod may have a shape in which a portion (for example, the intermediate portion) other than the base end portion is bent.

1. A transmission device comprising:
a transmission case including at least first and second cases detachably coupled to each other;
a transmission mechanism having a transmission shaft rotatable in the transmission case and housed in the transmission case; and
a parking lock mechanism configured to lock the transmission shaft as required and provided in the transmission case,
the parking lock mechanism comprising:
a parking gear provided to the transmission shaft in a manner non-rotatable relative to the transmission shaft;
a parking pawl configured to lock the parking gear by engaging with the parking gear;
a rod driven to move the parking pawl to a lock position for engagement with the parking gear and an unlock position for disengagement from the parking gear;
a detent arm whose base portion is rotatably supported by the first case and which is coupled to the rod so that the rod is driven by rotation thereof; and
a detent spring disengageably engaged with a tip portion of the detent arm to resiliently hold the detent arm in a specific arm rotation position,
wherein the detent arm has a rotation fulcrum located in the first case while an engagement portion between the detent arm and the detent spring is located in the second case, and
wherein the first case is provided with a support protrusion protruding toward the second case relative to a mating surface between the first and second cases, and a fixed end portion of the detent spring is attached to the support protrusion on the second case side relative to the mating surface.

2. The transmission device according to claim 1, wherein the support protrusion is configured by a support member separate from the first case, and the support member is fixed to the first case.

3. The transmission device according to claim 2, wherein the support member has a rod guide portion that guides a movement of the rod.

4. The transmission device according to claim 1, wherein the rod extends in a direction substantially orthogonal to a rotation axis of the detent arm as viewed in a projection plane orthogonal to the transmission shaft, and is arranged to overlap with the detent spring in an axial direction of the transmission shaft.

5. The transmission device according to claim 2, wherein the rod extends in a direction substantially orthogonal to a rotation axis of the detent arm as viewed in a projection plane orthogonal to the transmission shaft, and is arranged to overlap with the detent spring in an axial direction of the transmission shaft.

6. The transmission device according to claim 3, wherein the rod extends in a direction substantially orthogonal to a rotation axis of the detent arm as viewed in a projection plane orthogonal to the transmission shaft, and is arranged to overlap with the detent spring in an axial direction of the transmission shaft.
